(19) United States
(12) Patent Application Publication
(10) Pub. No.: US 2005/0068420 A1
(43) Pub. Date: Mar. 31, 2005

(54) All in one capture station for creating identification documents

(76) Inventors: Charles F. Duggan, Merrimack, NH (US); Leo M. Kenen, Bedford, MA (US); Nelson Schneck, Hollis, NH (US); David Bohaker, Chelmsford, MA (US)

Correspondence Address: DIGIMARC CORPORATION, 9405 SW GEMINI DRIVE, BEAVERTON, OR, 97008, US

(21) Appl. No.: 10/676,362

(22) Filed: Sep. 30, 2003

(51) Int. Cl. H04N 5/225

(52) U.S. Cl. 348/207.11; 348/373; 348/211.3

(57) ABSTRACT

An all in one capture station for creating photo identification documents combines the functions of a camera assembly and computer workstation into a single device. This device can be operated in a shared mode where it is controlled via one or more other workstations, or a stand alone mode, where it performs all of the functions needed to prepare an identification document. The all in one capture station includes a camera stand, a camera mounted within the camera stand, and a computer integrated into the camera stand. The computer includes a processor, network interface device, and memory. The memory stores a camera control program and a network interface program for transferring camera control commands and image data between the capture station and a remote workstation so that the capture station can operate under the control of the remote workstation to capture data for incorporation into an identification document.

### FIELD OF THE INVENTION

The invention relates to a capture station and related systems and methods for creating identification documents.

### BACKGROUND AND SUMMARY

In typical systems for capturing photos for identification documents, the camera assembly and workstation used to control it are separate devices. This type of capture configuration is more difficult to transport and configure in an office setting and is more costly because it involves two physically separate machines. It also presents challenges in sharing the capture station among more than one station operator, adding cost and inconvenience.

In one approach to enable sharing of the camera assembly, the workstation that controls the camera assembly may be connected to other workstations in a computer network. This network configuration enables the other workstations to issue image capture and transfer commands to the workstation directly connected to the capture stand. However, this configuration presents more costs and challenges because all capture control commands and associated data flow from a source workstation to a destination workstation connected to the camera assembly, and the destination workstation may not always be available. A typical problem is where the destination workstation is not logged on due to the absence of office personnel responsible for that station. In this case, the workstation is not able to process requests for image capture and transfer from other workstations.

In addition, this configuration requires at least three machines to operate in a networked environment: two workstations and a separate camera assembly.

The invention provides an all in one capture station and related methods, system and software for creating identification documents. One aspect of the invention is the all in one capture station, which combines the functions of a camera assembly and workstation into a single device. This device can be operated in a shared mode where it is controlled via one or more other workstations, or a stand alone mode, where it performs all of the functions needed to prepare an identification document. The all in one capture station includes a camera stand, a camera mounted within the camera stand, and a computer integrated into the camera stand. The computer includes a processor, network interface device, and memory. The memory stores a camera control program and a network interface program for transferring camera control commands and image data between the capture station and a remote workstation so that the capture station can operate under the control of the remote workstation to capture data for incorporation into an identification document.

The foregoing and other objects, aspects, features, and advantages of this invention will become even more apparent from the following description and drawings, and from the claims.

### BRIEF DESCRIPTION OF THE DRAWINGS

The foregoing features of this invention, as well as the invention itself, may be more fully understood from the following description and the drawings in which:

FIG. 1 illustrates an example of a capture station;

FIG. 2 is a perspective view of a shadow reduction device used with the capture station of FIG. 1;

FIG. 3 illustrates reduced shadows formed on a backdrop using the shadow reduction device of FIG. 1;

FIG. 4 is a front cross section view of the shadow reduction device of FIG. 1;

FIGS. 5A-C are front, side, and enlarged schematic views, respectively, of a capture station;

FIG. 6 is a front perspective view of a portion a shadow reduction device used on a capture station;

FIG. 7 is an exploded perspective view of the shadow reduction device of FIG. 6;

FIG. 8 is a rear perspective view of the shadow reduction device of FIG. 6;

FIGS. 9A-C are cross sectional views taken along the A-A, B-B, and C-C lines, respectively, of FIG. 6;

FIGS. 10A-E are illustrative examples of cross sectional views of the shadow reduction system of FIG. 6;

FIG. 11 is an alternative version of FIG. 1 showing an integrated computer and related components in an all in one capture station;

FIG. 12 is a system diagram illustrating a typical computing environment in which the all in one capture station is used; and

FIG. 13 is a flow diagram illustrating an example of photo identification document enrollment process.

The drawings are not necessarily to scale, emphasis instead is generally placed upon illustrating the principles of the invention. In addition, in the drawings, like reference numbers indicate like elements.

### DETAILED DESCRIPTION

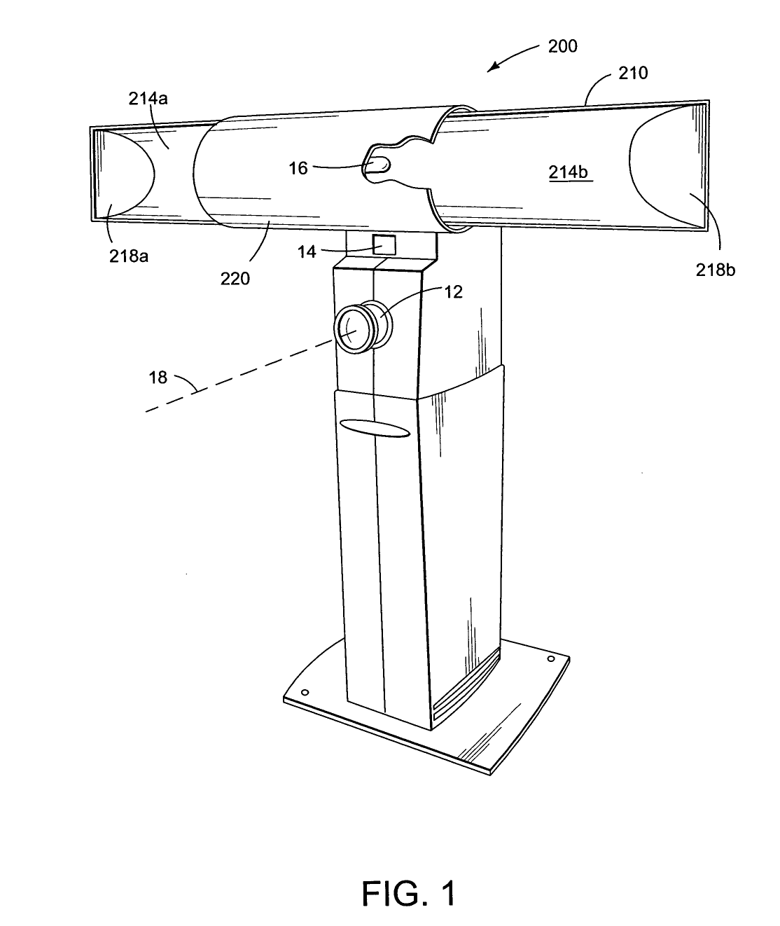

FIG. 1 illustrates a capture station 10, that includes an image capture device 12, such as a video camera and lens, a light sensor 14, and an light source 16 (element 220 is drawn with a break away to reveal the light source). In operation, the capture station 10 is controlled by built in computer (detailed below) to provide light directed toward a subject (applicant for identification document) and to capture a digital image of the subject. Together, the light sensor 14, and a light source 16 operate as a lighting device. An exit aperture plane can be defined to include the surface of the light source 16 through which the light is directed. The image capture device 12 has an observation axis 18 that is orthogonal to the exit aperture plane of the light source 16. In one embodiment, the light sensor 14 is provided by a strobe sensor, and the light source 16 is an electronic strobe. The light sensor 14 provides a real time adjustment to the light source 16 illumination of the subject by sampling light reflected off the subject and directed back to the light sensor 14. The strobe can optionally include a diffuser cover.

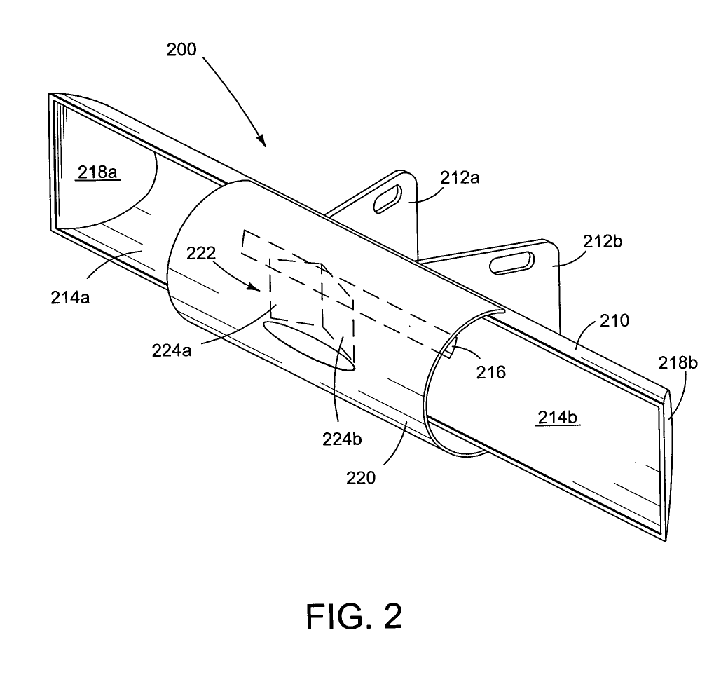

An exemplary lighting device 200 includes a housing 210 which includes diffusely reflective inner surfaces 214a and 214b coupled to diffusely reflective end portions 218a and 218b, respectively. The lighting device 200 further includes a diffuser 220 disposed on the housing 210. A reflector 222 is not visible in FIG. 1, but is shown in FIG. 2. In one embodiment, the lighting device 200 is adapted to mount directly onto the capture stand 10 without requiring any changes to the workstation control software and hardware and without modification to the image capture device 12, the light sensor 14, and the light source 16. The image capture device 12 has an observation axis 18 which is generally aligned with light reflected from the inner surfaces 214a and 214b directed onto the subject. It will be appreciated by those of ordinary skill in the art that image capture device 12 may include, but is not limited to, a video camera and associated frame or field capture device, a digital camera, or a CCD or CMOS image sensor. The image capture device 12 is coupled to a built in computer (described below) by means of a video signal interface or a digital interface.

The lighting device and stand housing of FIG. 1 can be formed using virtually any material and/or combination of materials, so long as the resultant device is capable of functioning in the manner described. For example, housing 210 of the illustrated lighting device 200 of FIG. 1 was formed using a plastic material, and the diffusively reflective surfaces (214a, 214b, 218a, 218b) within it were created by coating the surfaces with a light colored paint. Those skilled in the art will appreciate, however, that the housing 210 and/or the diffuser 220 can be formed using virtually any type of material capable of being formed into the desired shape and (in the case of the diffuser) providing the desired optical properties, including but not limited to metal, cardboard, glass, fabric, paper, wood, paperboard, ceramic, rubber, along with many man-made materials, such as microporous materials, single phase materials, two phase materials, coated paper, synthetic paper (e.g., TYVEC, manufactured by Dupont Corp of Wilmington, Del.), ABS, polycarbonate, polyolefin, polyester, polyethylenetelphthalate (PET), PET-G, PET-F, and polyvinyl chloride (PVC), and combinations thereof. In one experiment, the inventors found that a satisfactory housing 210 could even be formed using a section of six (6) inch diameter white plastic plumbing pipe.

Many different methods of forming the housing 210 are usable, including milling, injection molding, stamping, welding, coupling several individual elements together using adhesive, screws, staples, etc.,

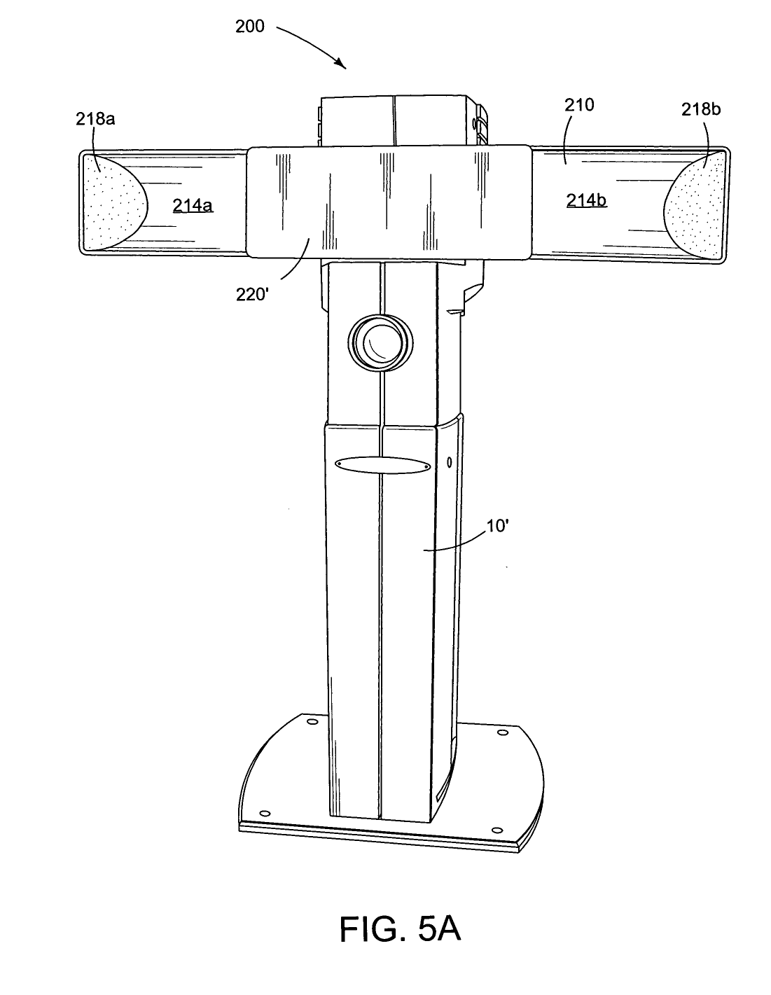

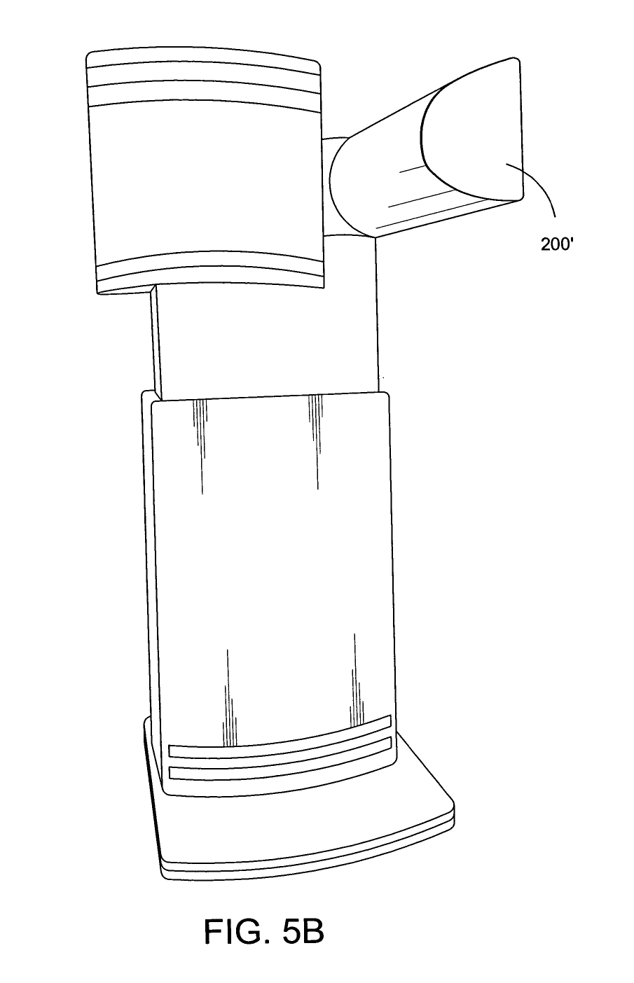

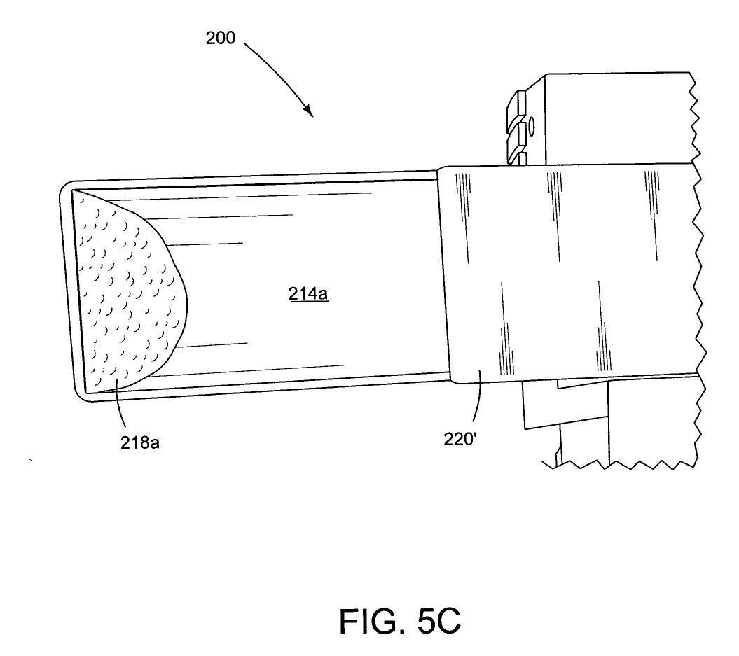

Further, the diffuser 220 is not limited to the shape or configuration shown in FIG. 1 (and FIG. 2). FIGS. 5-7 herein provide another illustrative example of a diffuser. The diffuser 220 can be virtually any shape or size that is capable of diffusing the light reflected back at it by the reflector 222 and the light that reaches it through the aperture 216 (see FIG. 2).

The materials used for the diffuser 220 and those used on one or more of the diffusively reflective surfaces 214a, 214b, 218a, 218b, are selected in a particular combination to produce a desired lighting effect on a subject. For example, in one embodiment, for one type of lighting condition, the more translucent the diffuser 220, the more reflective the diffusively reflective surfaces 218a, 218b need to be. The materials used for the diffuser 220 and those used on one or more of the diffusively reflective surfaces 214a, 214b, 218a, 218b, also can be selected based on the lighting source used and/or the reflector 222.

The lighting device 200 of FIG. 1 can be implemented using housings, reflectors, diffusers, and materials of varying shapes and types. For example, in one embodiment, the diffusively reflective inner surfaces 214a, 214b and the diffusively reflective end portions 218a, 218b are formed from the same material. In one embodiment, the diffusively reflect inner surfaces 214a and 214b comprise a different surface material than the diffusively reflective end portions 218a and 218b.

Further, the housing 210 can have virtually any shape so long as the shape is conducive to permitting light to illuminate a subject as desired. Experimentation has shown that shapes that have at least some curvature to them (e.g., shapes having curved portions, such as cylindrical shapes, parabolic shapes, round shapes, etc.) have been found to be advantageous, but other shapes may be used as well.

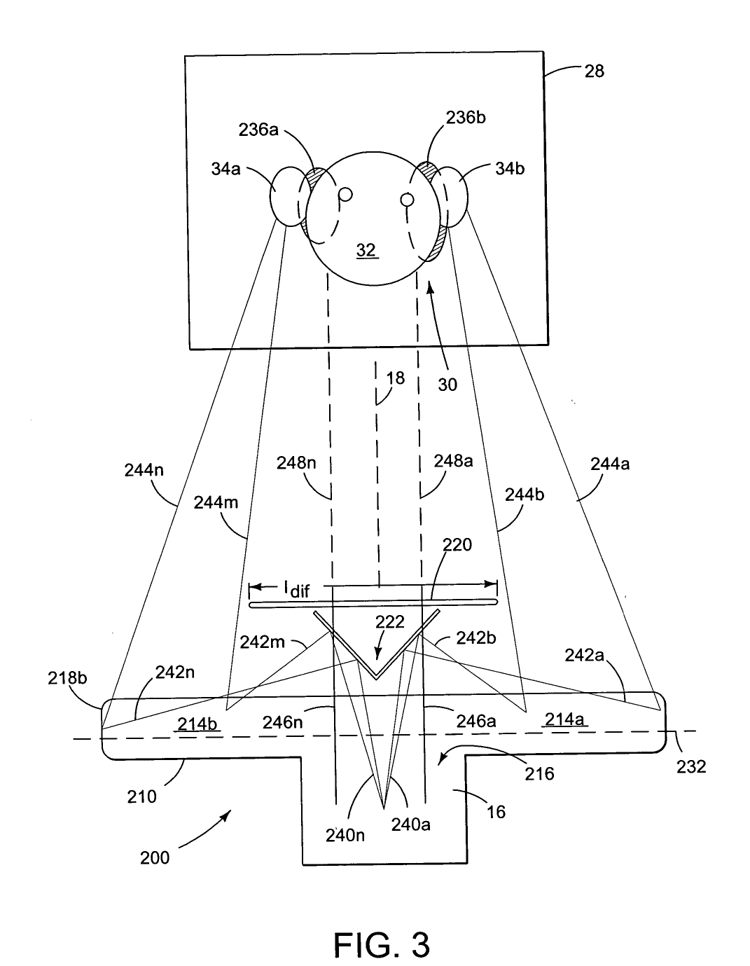

Referring now to FIG. 2, an exemplary lighting device 200 includes a housing 210 having mounting brackets 212a and 212b and an aperture 216 centrally disposed in the housing 210 and aligned with a capture station light source when the device 200 is mounted to the capture station. The housing 210 further includes diffusely reflective inner surfaces 214a and 214b coupled to diffusely reflective end portions 218a and 218b, respectively. The lighting device 200 further includes a diffuser 220 disposed on the housing 210 and a reflector 222. In FIG. 2, the reflector 222 includes a pair of specularly reflective surfaces 224a and 224b. In one embodiment, the specularly reflective surfaces 224a, 224b are mirrors or mirror-like surfaces. In one embodiment (shown in FIG. 3), the specularly reflective surfaces 224a, 224b of the reflector 222 are fixedly coupled together (and can even be formed as a unitary member) In one embodiment, the entire housing 210 inner surface including portions behind the diffuser 220 and surrounding the aperture 216 comprises diffusely reflective inner surfaces. The diffusively reflective surfaces need not all be formed from the same material. For example, in one embodiment (illustrated in FIGS. 5A-C), the diffusively reflective end portions 218a, 218b have diffusively reflective surfaces formed from a different material than the rest of the diffusively reflective surfaces in the housing 210.

In at least some embodiments, at least one or more of the inner surfaces 214a, 214b, 218a, 218b of the housing 210 are specularly reflective. Using a specularly reflective surface can increase the light transmitted to the subject being illuminated, but use of too many specularly reflective surfaces may increase and/or alter the shadows in an undesirable manner.

In one embodiment, the housing 210 includes, e.g., one half of a four-inch diameter plastic pipe. In this embodiment this housing 210 is approximately 24 inches long. Portions of the inner surfaces 214a and 214b of the housing 210 which reflect light from the reflector 222 onto the subject are coated with a white, opaque, diffusely reflective material. In one embodiment, the inner surfaces 214a and 214b are painted with a white matte finish paint, for example, Flat White 1502 Krylon® manufactured by the Sherwin-Williams Company. In one embodiment, the diffuser 220 is a semi-cylindrical translucent plastic material attached to the housing. In this embodiment, the specularly reflective surfaces of the reflector 222 include a pair of mirrors 224a and 224b attached to the diffuser 220 and arranged directly in front of the light source, here an electronic strobe. In this embodiment, the reflector 222 is sized and angled so that it is as wide as the size of the flash of the strobe, to be able to reflect the light. Note also that the capture station can be used with non-electronic strobes, pulsed strobes, and many other types of light sources.

The mirrors 224a and 224b are configured at a 90 degree angle with respect to each other and each mirror 224 forms a 45 degree angle with the exit aperture plane of the light source, such that light is reflected from the light source off the mirrors 224 and off the inner surfaces 214a and 214b and the end portions 218a and 218b of the housing 210 onto the subject. In this embodiment, the mirrors 224a and 224b intercept more than fifty percent of the illumination from the light source passing through the aperture 216. In one embodiment, the mirrors intercept about 67 percent of the illumination. The mirrors 224a and 224b optionally include an antireflective coating. It should be noted that the reflector 222 need not have the rectangular shape shown, but can be virtually any shape (e.g., round, triangular, octagonal etc.

It will be appreciated that the particular angles shown for the reflector 222 are not limiting and can be any angle capable of permitting light from the light source to reach the subject being illuminated.

The dimensions, angles, diffuser materials and inner surface coating materials can be varied to accommodate different capture stands, light sources and subject and backdrop arrangements.

In this embodiment, the end portions 218a and 218b are arranged at an angle, e.g. a 45-degree angle with respect to the inner surfaces 214a and 214b and coated with the same diffuse reflecting coating as the inner surfaces 214a and 214b. Generally, the angle at which the end portions 218a, 218b are arranged will be selected based at least in part on the angle of the reflector 222. For example, in FIG. 2, the angle of the end portions 218a, 218b is substantially the same as the angle of the exit aperture plane of the light source. However, depending on the application, it may be desirable for the end portions 218a, 218b to be at a substantially different angle than that of the exit aperture plane of the light source. Thus, both the area of the inner surfaces 214a and 214b and the alignment of the orientation of the light reflected from the inner surfaces 214a and 214b with respect to the observation axis 18 can be varied without substantially affecting the size and location of visible shadows.

Referring again to FIGS. 1 and 2, in operation a predetermined portion of the light from the light source is reflected by the reflector 222 and re-directed by the inner surfaces 214a and 214b and the end portions 218a and 218b of the housing 210 such that the subject is illuminated with diffuse light that effectively functions as indirect side lighting which may eliminate most of the visible shadows on the backdrop or on the subject's hair which are captured by the image capture device. The reflected illumination is directed from two sources corresponding to the inner surface 214a and the end portion 218a, and the inner surface 214b and end portion 218b, respectively. A projection of these sources onto a plane orthogonal to the observation axis 18 lies substantially outside a projection of the subject's head onto the same plane.

The remainder of the light, which is not reflected by the reflector 222, passes through the diffuser 220 and is transmitted to indirectly illuminate the subject. Therefore the light source does not directly illuminate the subject because the illumination is balanced between diffused lighting in a face-on direction and diffused reflective side lighting. The diffuser 220 also functions as a protective cover concealing the light source and the reflector 222.

Referring now to FIG. 3, an arrangement for capturing a digital image of a subject 30 located in front of a backdrop 28 includes the capture stand and lighting device 200 of FIGS. 1 and 2, disposed directly facing the subject 30 along the observation axis 18. It has been found that when using the lighting device 200 that varying the color of the backdrop can affect the quality of the shadow reduction. In some conventional applications, use of a blue colored backdrop 28 has been found to provide optimal image quality. However, use of a light colored (e.g., substantially white) backdrop can optimize the shadow reduction features of the lighting device.

Referring again to FIG. 3, the subject 30 has a head 32 and ears 34a and 34b. Typically the ears 34a and 34b are disposed on the sides of the head 32 and protrude slightly from the head 32. When commanded by the capture workstation (not shown), the light source 16 provides illumination which can be considered a plurality of light beams 240a-240n and 246a-246n which are directed through the aperture 216 toward the reflector 222. The light beams 240a-240n are reflected off the reflector 222 and become beams 242a-242n which are reflected off of diffusely reflective inner surfaces 214a and 214b and diffusely reflective end portions 218a and 218b and become beams 244a-244n which are directed toward the subject 30.

Other light beams 246a-246n are directed through the aperture 216 toward the diffuser 220. The beams 246a-246n emerge from the diffuser 220 as diffuse light beams 248a-248n and are directed toward the subject 30. Because the light beams 248a-248n have been diffused by the diffuser 220, any light spot reflections from glasses are reduced and the skin tone appearance is improved. Additionally, since the width of the diffuser 220 (measured along a longitudinal axis 232 of the housing 210) is wider than the width of the subject's head 32, much of the light illuminating the subject effectively is coming from the both sides of the subject instead of directly in from of the subject. The diffusely reflective end portions 218a and 218b are arranged to further direct light from the reflector 222 onto the subject. Although the shadows 236a and 236b are formed on a backdrop 28, the shadows 236a and 236b are only partially visible to the image capture device 12 which receives a plurality of light beams (not shown) forming the shadows 236a and 236b. Relatively large portions of the shadows 236a and 236b lie behind the head 32 when viewed by the image capture device 12 along observation axis 18.

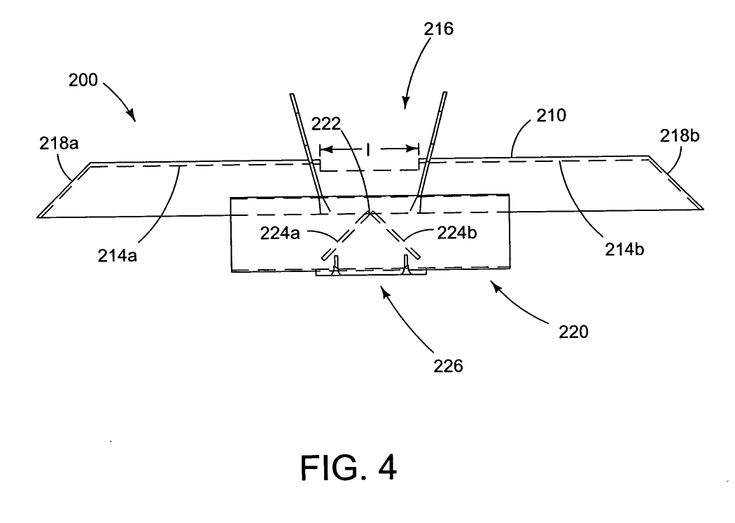

Referring now to FIG. 4 in which like reference numbers indicate like elements of FIGS. 1 and 2, the exemplary lighting device 200 further includes a reflector mount 226 which is coupled to the diffuser 220. In one embodiment, the aperture 216 has a length l of approximately 3.5 inches and a width of approximately 2 inches, the diffuser is approximately 10 inches, and a plane of the housing 210 forms an angle of 45 degrees with a plane of the diffusely reflective end portions 218a and 218b, respectively. Of course, these dimensions are not limiting, but rather are provided by way of example.

In one embodiment, a lighting device (not shown) includes a light source disposed within the housing and a light sensor disposed on the housing to receive light reflected from the subject. The light source is coupled to a light source control disposed either internally within the housing or external to the housing.

FIGS. 5A-C are front, side, and enlarged schematic views, respectively, of a lighting device 200. The lighting device 200 is shown coupled to a capture stand 10′ similar to the capture stand 10 of FIG. 1. FIG. 5C is an enlarged view of section 400 of FIG. 5A. FIGS. 5A-C illustrate a lighting device 200 in which the diffusively reflective end surfaces 218a, 218b are of a different material than the diffusively reflective inner surfaces 214a, 214b. Referring to FIG. 5C, in this embodiment, the diffusively reflective end surfaces 218a, 218b comprise so-called “supersoft” reflector material capable of producing wide lighting coverage over short distances. One example of a usable reflector material for the diffusively reflective end surfaces 218a, 218b is Roscoflex SS #3804, which is available from Rosco Laboratories, Inc., of Ontario Canada. In addition, the instant inventors have found that a wide range of diffusively reflective materials are usable on the diffusively reflective end surfaces 218a, 218b, including mirrors and mirror-like surfaces, metallic foils, metallic mesh, grated surfaces, metallic coatings, textured coatings, textured reflective materials, etc. The diffusively reflective end surfaces 218a, 218b can be formed using combinations of materials, as well. For example, the diffusively reflective end surface 218a could comprise an outer “ringed” portion of Roscoflex #3804 with an inner portion of mirrored material. Those skilled in the art will appreciate that many combinations of materials are usable.

In the embodiment of FIGS. 5A-C, the diffusively reflective inner surfaces 214a, 214b of the lighting device 200 are formed by applying two layers of light colored semi gloss paint over the surface of the housing (which in this embodiment is plastic, by way of example only). The first layer of semi gloss paint is applied then, before that layer is completely dry, another layer is applied over it. This technique has been found to further improve the diffusive properties.

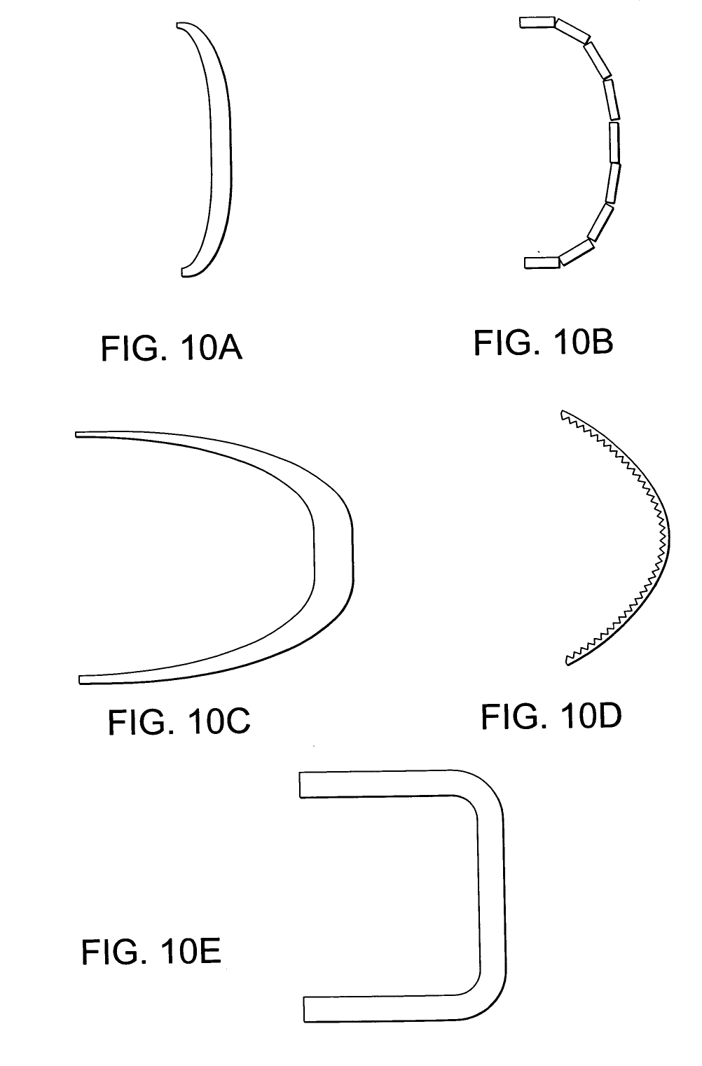

The resultant diffusively reflective inner and end surfaces 214a, 214b, 218a, 218b need not be completely or even partially smooth, so long as the light is able to be properly reflected and/or diffused. For example, in the embodiment of FIGS. 5A-C, the diffusively reflective end surfaces 218a, 218b have a tactile texture (because of the Roscoflex #3804) whereas the diffusively reflective inner surfaces 214a, 214b have a texture that is less pronounced. FIG. 10, described further herein, provides illustrative examples of surfaces that can be used in at least some embodiments.

Further, although the lighting device 200 is illustrated as having a curved, at least partially semi-cylindrical shape, other shapes may be used. In one embodiment, the lighting device 200 can be virtually any shape (e.g., substantially conical, triangular, rectangular, square, elliptical, parabolic, trapezoidal, etc.), so long as at least a portion of the lighting device 200 is curved, even if the curve is relatively flat and/or irregular.

Referring again to FIG. 5A, in this embodiment, the diffuser 220′ of the lighting device 200 differs from the diffuser 200 of the lighting device of FIGS. 1 and 2. In this embodiment, the diffuser 220′ has a substantially flat shape and is coupled to the top and bottom of the housing 210. This is illustrated further in FIG. 6, which is a diagrammatic front perspective view of a portion the lighting device 200 of FIG. 5A. Although the shape of the diffuser 220′ differs from the diffuser 220 of FIGS. 1 and 2, like the earlier diffuser 220, the diffuser 220′ can be formed form any material (or combination of materials) capable of diffusing light while permitting a portion of the light to transmit therethrough (to illuminate at least the front of the subject). In the embodiment shown in FIG. 5A, the diffuser 220′ is formed into a substantially rectangular shape and comprises LEXAN, which is available from General Electric Corporation, GE Plastics, Pittsfield, Mass.

Other materials usable for the diffuser 220 include virtually all known light diffusing materials, such as frosted and textured glass and plastic, fabric, thin plastic films, latex, paper, synthetic paper, laminates, transparent materials coated with light diffusing coatings, glazes, etc.

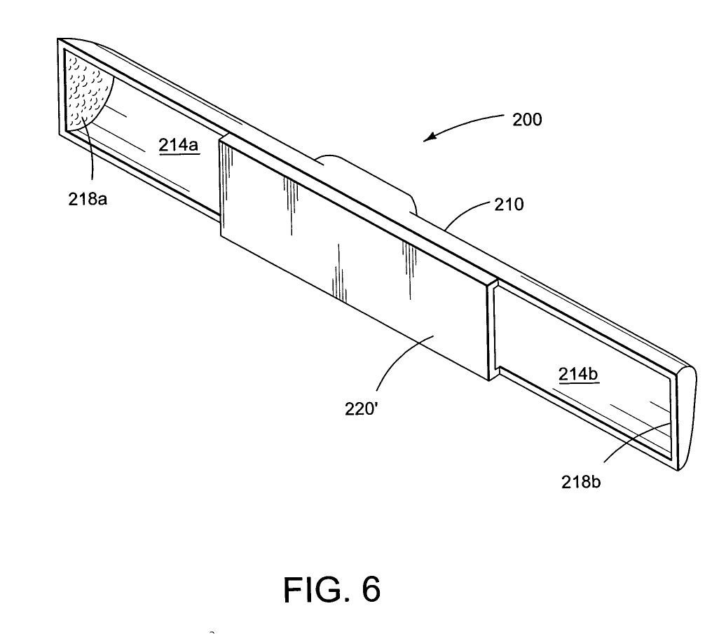

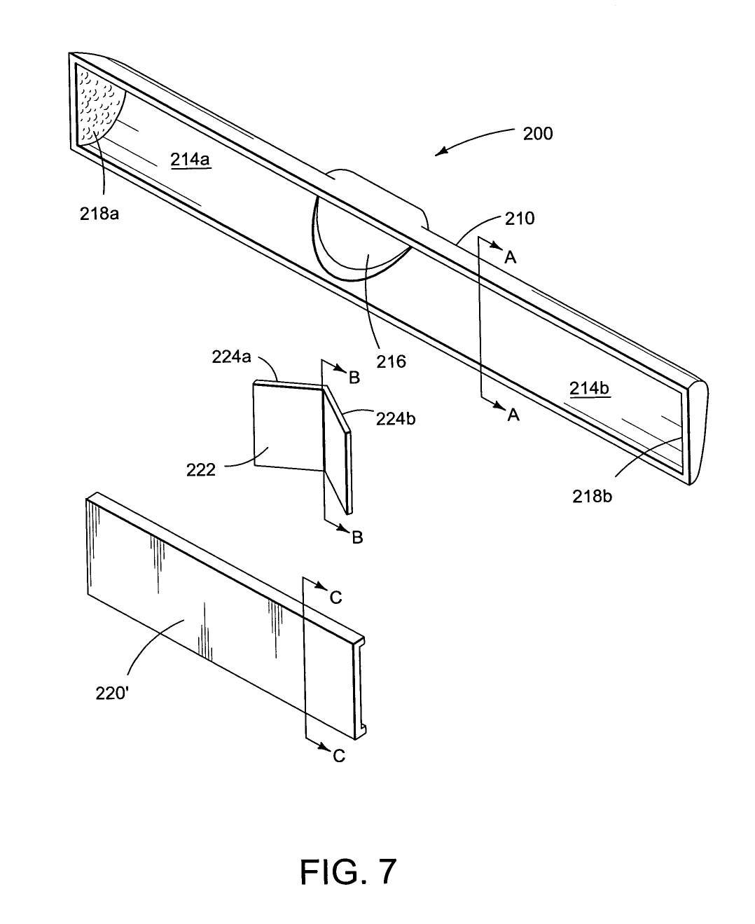

FIG. 7 is a diagrammatic exploded perspective view of the lighting device 200 of FIG. 6, showing illustrative embodiments of the housing 210, reflector 222, and diffuser 220′. The housing 210 has formed thereon aperture 216 through which the light source (not shown) is able to transmit and be reflected off the reflecting surfaces 224a, 224b as well as be diffused through the diffuser 220′, and be further diffused and reflected off the diffusively reflective end surfaces 218a, 218b. The reflector 222 can be coupled to either the housing 210 or the diffuser 220′. The diffuser 220′ can be directly coupled to the housing 210 or can be coupled to the reflector 222, which can be coupled to the housing 210. The methods by which the diffuser 220′, reflector 222, and housing 210 are attached together so that light passing through the aperture 216 is prevented from directly impinging on the subject whose image is being captured, to help prevent the formation of shadows (or at least reduce the size of the shadows) in the image.

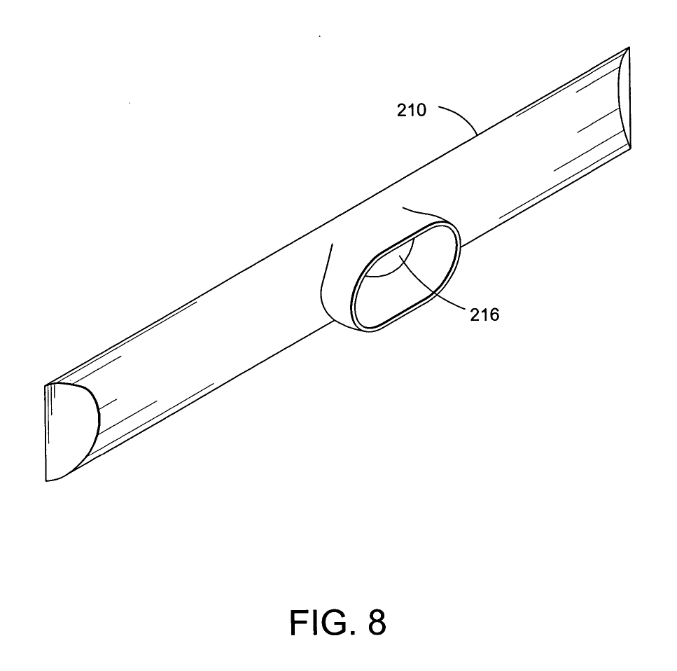

FIG. 8 is a diagrammatic rear perspective view of the lighting device of FIG. 6, illustrating the formation of the aperture 216.

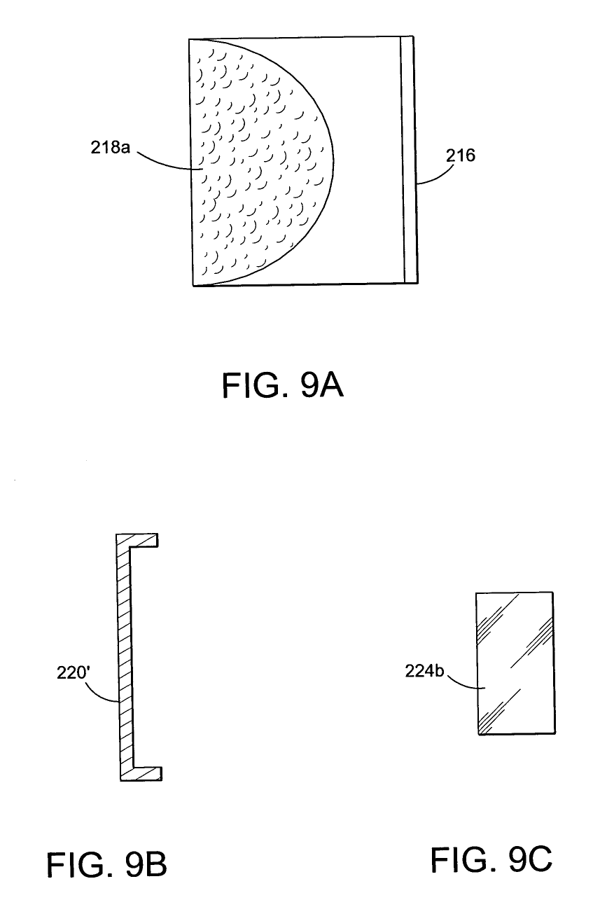

FIGS. 9A-C are illustrative cross sectional views taken along the A-A, B-B, and C-C lines, respectively, of FIG. 6. FIG. 9A shows a cross sectional view of the housing 210, showing both the aperture 216 and one the diffusively reflective end surface 218a. FIG. 9B shows a cross sectional view of the reflector 222, showing a specularly reflective surface 224b. FIG. 9C shows an illustrative cross sectional view of the diffuser 220′.

FIGS. 10A-E are illustrative examples of cross sectional views of some embodiments of the lighting device 200 of FIG. 6. These cross sectional views are not, of course, exhaustive in showing the many ways the lighting device 200 can be implemented, but help to illustrate various usable shapes. FIG. 10A shows a substantially flat cross sectional surface possessing a slight curvature. The cross sectional surface of FIG. 10A could, for example, be part of a lighting device 200 having a virtually any shape-rectangular, square, elliptical, triangular, etc. FIG. 10B shows how a plurality of substantially straight surfaces (e.g., like the many mirrored surfaces of a “disco ball”) can be coupled together, constructed, and arranged, to form a lighting device 200 having a curved cross section. FIG. 10C shows a cross section having a significant degree of curvature. FIG. 10D shows a cross section with some curvature, but which has a highly textured, non-smooth surface. The surface of FIG. 10D can, for example, comprise a plurality of ridges, raised “bumps”, indentations (e.g., like a golf ball), and the like. FIG. 10E shows a cross section that comprises mostly straight surfaces with rounded edges.

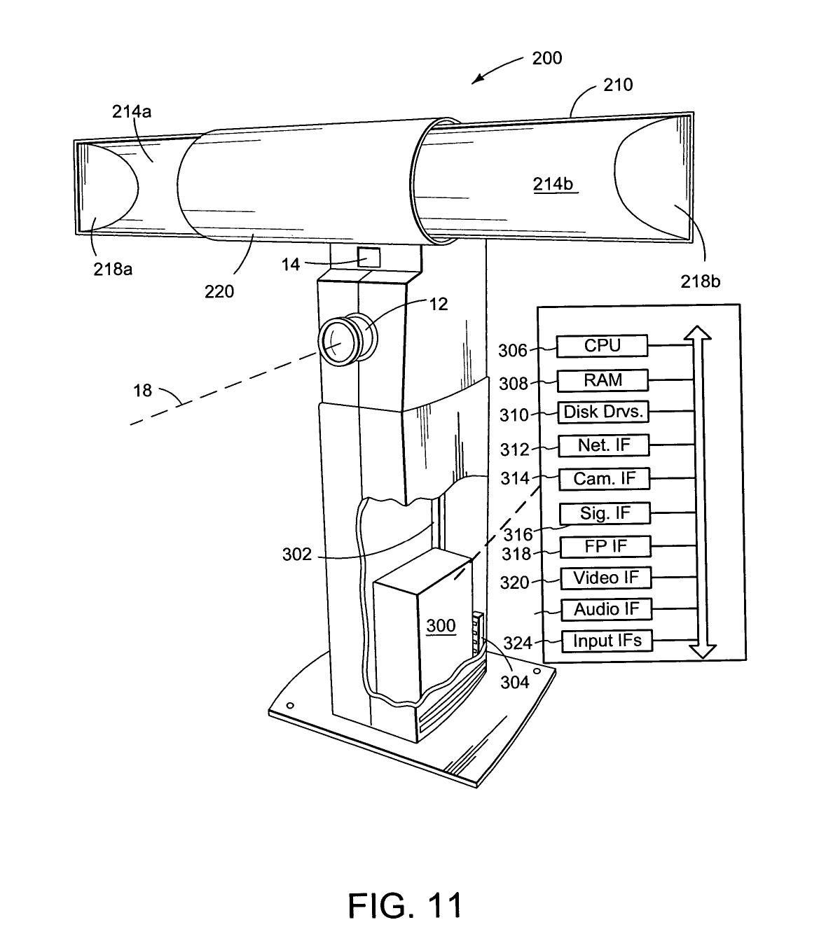

As described above, a computer is integrated into the capture stand to form an all in one capture station. FIG. 11 is an alternative depiction of FIG. 1 with a break away view revealing a computer 300 inside the capture station. The computer is powered via electrical wiring inside the capture station that also powers the camera and lighting device. In particular, a power strip 304 is mounted at the base of the capture station, and the computer, camera and lighting device plug into the power strip. The electrical and data wiring for the camera, computer, and external ports are consolidated in a conduit 302 in the rear of the capture station. Both the camera and the computer have power supplies to convert line voltage to the voltage/current for the camera and computer electronics. The strobe in the lighting device is connected to the line voltage.

As shown in FIG. 11, The computer includes a processor 306, memory devices (RAM 308 and persistent storage such as fixed and removable disk drives 310), and peripheral/interface devices, such as a network device interface (e.g., Ethernet card) 312, a camera and lighting device interface (e.g., USB port, Firewire interface, etc) 314, signature capture device interface (e.g., USB port) 316, and a fingerprint capture device interface (e.g., USB port) 318. In addition, the capture station can be transformed into a fully functioning computer workstation by plugging in a video monitor through its video device interface 320, speakers through its audio device interface 322, keyboard (e.g., folding keyboard) and cursor control device (e.g., mouse) through input device interfaces 324.

In one particular configuration for creating driver's licenses, the all in one capture station includes a digital camera (e.g., 4 Megapixel resolution digital camera) and a professional quality strobe mounted in the camera tower of the capture station, and a personal computer from Via Technologies, Inc. (Fremont, Calif.) mounted in the base of the station. The tower is slidably connected to the base enabling the operator to adjust the height of the camera. The tower is detachable from the base to facilitate transport.

The computer system can be incorporated into the camera stand by installing a mainboard with CPU, memory, USB ports, network device interface, etc. from Via Technologies inside the base of the camera stand housing. At least some of the ports, such as the network device interface, and some of the USB ports are connected to an outer wall of the base and are exposed on the outside of the stand to enable connection to other devices such as signature capture pads, scanner, fingerprint capture, etc.

The combination of the camera and camera software component in the computer provides complete automatic focusing, contrast correction and cropping that ensure consistent and uniform portraits. The automated process is instantaneous and allows multiple operators from networked workstations to capture applicant portraits from sitting or standing positions without adjustment or intervention of any kind. This ease of operation produces significant efficiencies in customer throughput. The multifunction capabilities of the workstation allow complete intake, portrait & signature image capture, and driver's license production from multiple different networked workstations, or alternatively from the all in one capture station itself.

The capture station's computer executes programs from its memory, including an operating system (e.g., Windows XP from Microsoft Corporation), network communication programs (e.g., BSD socket software, TCP/IP and UDP software), a camera control module, a fingerprint capture module, a signature capture module, and other programs and data.

The network interface 312 and network communication software enables the computer in the capture station to communicate with two or more other computer workstations. In this embodiment, the network interface is an Ethernet network interface, but other alternative networking hardware and related communication protocols can be used. For example, an operator can control the all in one capture station from a tablet PC, PDA or other portable computing device via a wireless connection to the capture station (e.g., according wi-fi standards such as 802.11b-g, etc.)

Among its network communication software, the all in one capture station includes capture device interface software. This capture device interface software enables any workstation connected to the all in one capture station via a network to control the functions of the capture stations, such as taking a picture, capturing signatures and fingerprints, and printing an ID card. This interface is an extension of a BSD socket software, which is responsible for establishing a network connection between the computer in the capture station and other workstations. The socket software sets up a network connection through a socket using TCP and/or UDP protocols. Executing on both the remote workstation and the all in one capture station, the socket software receives requests to transfer instructions and data. In response, it transforms instructions/data into packets for sending through the socket. The extension to this interface adds an application programming interface and corresponding code modules to provide function calls that enable capture station control functions. These functions can be grouped according to the devices in the capture station, such as the camera, the signature capture device, the identification document printer, the fingerprint capture device, and the machine-readable code reader (e.g., bar code reader; magnetic stripe reader, smart card reader, optical memory device reader, digital watermark reader, etc.).

For example, the camera control functions includes functions such as “Start the camera”, “Initialize the camera”, “Capture an image”, “Close the camera”, etc. Similarly, the signature capture functions include, “Start the signature pad”, “Initialize the signature pad”, “Capture a signature”, “Close the signature pad”, etc. The control functions for the fingerprint capture device are similar.

The computer in the all in one capture station operates in a “service mode” which enables the networking software and capture device software modules to execute without requiring a user to log on to the system. In one specific implementation, the service mode is the “service mode” of the Windows XP operating system executing in the all in one capture station.

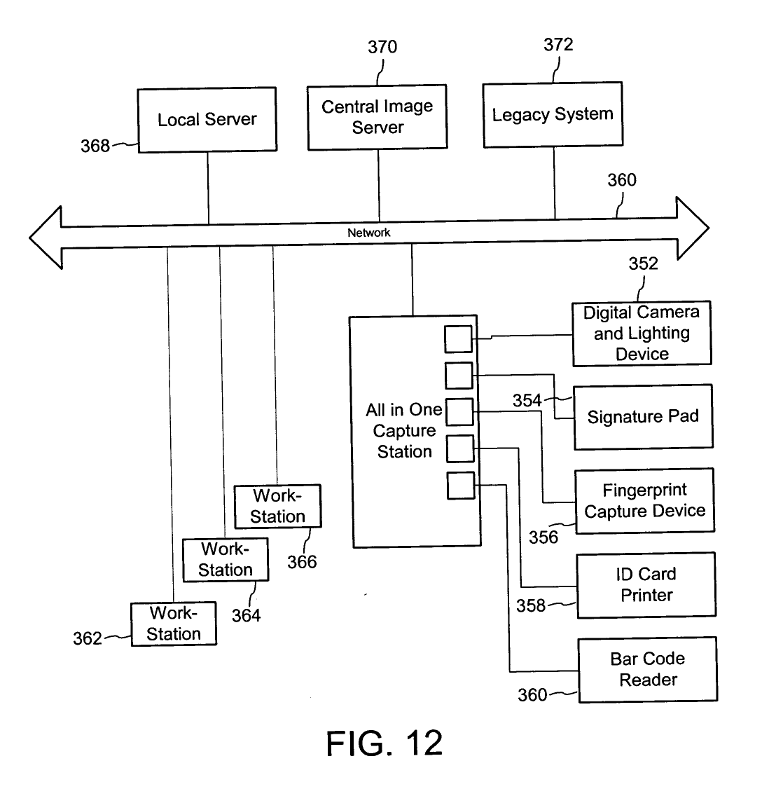

FIG. 12 illustrates a typical configuration of workstations and the all in one capture station in an identification document enrollment facility. In this configuration, the all in one capture station 350 includes a digital camera and lighting device 352 as shown in FIG. 11, and is connected to a signature pad 354 for capturing handwritten signatures of applicants, a fingerprint capture device for capture fingerprints (e.g., for biometric log on authentication and/or capturing applicant fingerprints) 356, an ID card printer 358 and a bar code reader 360 through its external ports.

The all in one capture station communicates with other computing devices via a network 360. Other networked devices include operator workstations (e.g., 362, 364, 366), which each share the all in one capture from the operator perspective. Additional networked devices include a local server 368, which stores data for local enrollment transactions, a central image server 370, which stores images and related applicant demographic and biometric data in files, and a legacy system 372, which generally refers to the identification document issuer's data processing system that manages applicant processing and applicant information. For instance, in the example document creation process outlined below, the legacy system stores applicant demographic information and is either polled by the workstation to get requested applicant data, or pushes the appropriate applicant data to the local server and/or workstation. This applicant data is then used to generate or renew identification documents in enrollment transactions performed in the workstations.

In a typical configuration, one or more workstations (362-366) are connected to the all in one capture station 350 via a network connection. Users of the workstations log on to the their systems, which include capture control software and BSD socket network communication software compatible with the all in one capture station. These users can enter or select any of a variety of commands via a capture station user interface. In response the socket interface packages these commands into packets and sends them to the counterpart socket interface on the all in one capture station computer. An example of the enrollment process will help illustrate the operation of the workstation and its interface with the all in one capture station.

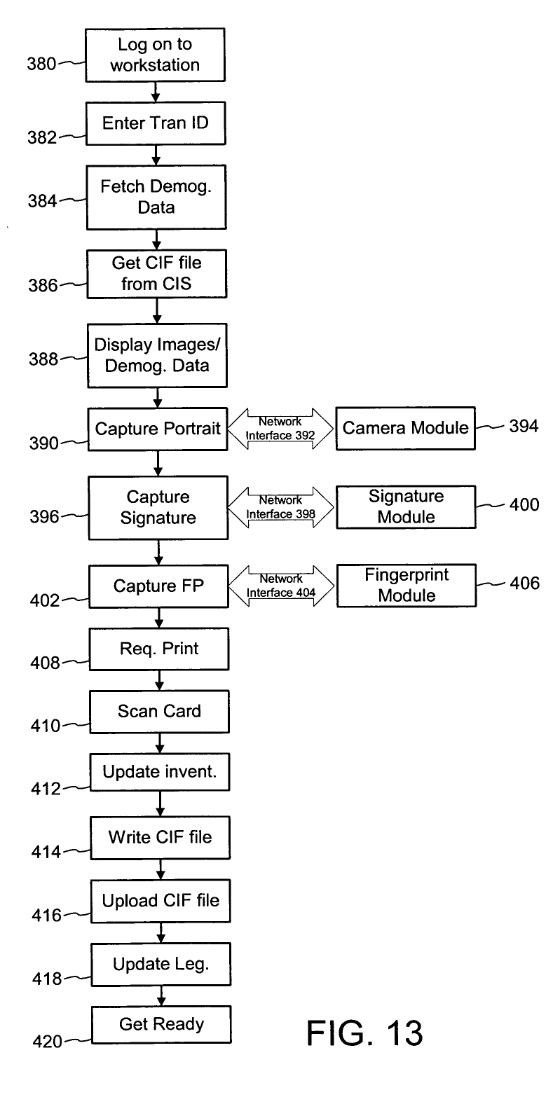

FIG. 13 is a flow diagram illustrating an example of the enrollment process in which a remote workstation controls the all in one capture station through its network interface. The workstation performs the process on the left, while the all in one capture station performs the process on the right in communication with the workstation.

The enrollment process begins when the operator logs onto the workstation (380). This may include biometric verification of the operator through a fingerprint capture station (e.g., either connected to the workstation or the all in one capture station).

At this stage, an enrollment application program, including a user interface and variety of modules for controlling capture and communication with other networked devices are executing within memory of the workstation.

The user interface provides an input text box for entering a transaction identifier. This transaction identifier identifies the applicant to the system. The operator enters this transaction identifier as shown in step 382.

In response, the enrollment program fetches demographic data of the applicant associated with the identifier (assuming this is a previously enrolled applicant) (384). In particular, it queries the legacy system through a legacy system interface module, which looks up the demographic data associated with the identifier and returns it to the workstation. As noted, this demographic data may be pre-loaded onto the workstation or local server via a data polling or data push model in which transaction identifiers for planned enrollment transactions are used to pre-load the demographic data of applicants. This process, of course, is skipped for new applicants for which no demographic data exists in the system.

Next, the workstation fetches a file including the applicant's portrait and other applicant information (e.g., signature, fingerprint, etc.) from a central image server (386) through a image server interface. The user interface then populates a display window with the applicant's picture and demographic information, if available (388).

The workstation operator is now ready to capture the applicant's portrait. The operator has the applicant sit in front of the camera of the all in one capture station. The enrollment software in the workstation prepares the camera in the all in one capture station via the network interface between the workstation and capture station. When the enrollment program calls cameral control functions in the camera programming interface, it identifies the destination all in one capture station. This interface, in turn, sets up a socket connection with its counterpart on the all in one capture station. Once this communication link is established, the workstation controls the camera in the all in one capture device via the network interface. The camera feeds video back to camera control software on the capture station, which in turn, forwards it back to the enrollment program on the workstation via the socket. The workstation's user interface then displays the live video from the camera in a window next to a collection of windows/text boxes displaying applicant's old portrait and other demographic information.

Next, the operator has the ability to capture a particular image via an input control on the workstation (390). In this example, the operator presses the spacebar to capture the applicant's portrait. The camera module then captures a single frame from the video feed and passes it to the enrollment program, which displays it in the window, which previously showed the live video feed. Alternatively, still image capture of the applicant photo and the video feed of the applicant are performed separately, and the data and commands for video and still image capture are communicated separately. The video feed enables the operator to view the applicant, and compare the applicant with any photos on file for that applicant. It also enables the operator to ensure that the applicant is in the correct position before capturing a still image for use in the identification document.

This process of image capture can be repeated if necessary. As shown in FIG. 13, the enrollment program (and specifically its camera control module in the workstation) controls the process of setting up a connection with the capture device, returning video, and finally, capturing a single portrait through the network interface 392 and the camera control module 394 executing in the all in one capture station.

The enrollment process then repeats a similar procedure to capture the applicant's signature and fingerprint (396, 402). In particular, a signature module on the workstation receives a request from the enrollment program to capture a signature (396). In response, it sets up the socket interface 398 and passes the request to the signature module 400 on the all in one capture station, which captures the signature and returns it via the socket to the enrollment program on the workstation.

The fingerprint module on the workstation receives a request from the enrollment program to capture a fingerprint (402). In response, it sets up the socket interface 404 and passes the request to the fingerprint capture module 406 on the all in one capture station, which captures the fingerprint and returns it via the socket to the enrollment program on the workstation.

Now that the enrollment program has captured all of the data for the identification card, it sends a request to a rendering program to render and print the card (408). The rendering program packages and transforms the data, including the photo, signature, and possibly the fingerprint, into a printable image format. This may include invoking still other programs to generate various machine-readable features, such as 2 D bar code and digital watermark (e.g., for embedding in the card's photo and background), and return printable versions of these features. Ultimately, the rendering program issues a request to the printer driver of an over the counter card printer to print the card.

The operator then gives the card to the applicant for inspection and verification of the accuracy of the data. If it's accurate and complete, the operator initiates a series of steps to complete the enrollment process. These include, for example, scanning the card with an image reader (410) to capture an image record of the card and to extract machine readable data from the card, such as the 2D bar code and digital watermark.

At this point, the enrollment program writes a new image file with the card portrait and related information (e.g., bar code, signature, fingerprint, etc.) as shown in step 414. It then uploads the file to the central image server via a image server interface (416). Now that the enrollment transaction is complete, it also update's the issuer's legacy system with the demographic and other card transaction information (418). The workstation now gets ready for the next applicant (420) (e.g., by destroying data structures created in the enrollment process and initializing new ones, etc.).

While we have used a specific example to illustrate the operation of the all in one capture station, the actual enrollment process can vary significantly. Cards need not be issued over the counter, but instead, can be issued from a central location, where cards are printed and mailed. The capture station uses a socket interface, but other forms of network interfaces may be used.

The capture station has been described in network operation mode, but it can also operate in a stand alone mode. As noted, the operator can simply plug in a video display and keyboard and then operate the capture station as a self contained card enrollment and issuing system. Alternatively, the capture station can be controlled by a portable computing device such as a Pocket PC, PDA or PC tablet via a wireless connection.

There are a variety of alternative ways to implement the enrollment program and its interface. One way is to implement the user interface of the enrollment program as a collection of web pages, and the core software and modules of the enrollment process as a web server application program, such as an Apache web server. In one particular embodiment for the all in one capture station, this web server executes on the all in one capture station. The web page interface (e.g., HTML coding) executes in a browser session, all running on a client device, such as a portable computer, PDA or PC tablet, connected via wireless (e.g., 802.11) or wired network connection to the all in one capture station.

At least some of the embodiments described herein can be implemented at least in part using software, hardware, or in a combination of hardware and software. Moreover, those of ordinary skill in the art will appreciate that the embodiments of the invention described herein can be modified to accommodate and/or comply with changes and improvements in the applicable technology and standards referred to herein. Variations, modifications, and other implementations of what is described herein can occur to those of ordinary skill in the art without departing from the spirit and the scope of the invention as claimed.

Although certain words, languages, phrases, terminology, and product brands have been used herein to describe the various features of the embodiments of the invention, their use is not intended as limiting. Use of a given word, phrase, language, terminology, or product brand is intended to include all grammatical, literal, scientific, technical, and functional equivalents. The terminology used herein is for the purpose of description and not limitation.

The particular combinations of elements and features in the above-detailed embodiments are exemplary only; the interchanging and substitution of these teachings with other teachings in this and the incorporated-by-reference patents/applications are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto.

All publications and references cited herein are expressly incorporated herein by reference in their entirety. Having described the preferred embodiments of the invention, it will now become apparent to one of ordinary skill in the art that other embodiments incorporating their concepts may be used. These embodiments should not be limited to disclosed embodiments, but rather should be limited only by the spirit and scope of the appended claims.

1. An all in one capture station for creating identification documents comprising:
a camera stand;
a camera mounted within the camera stand;
a computer integrated into the camera stand; the computer including a processor, network interface device, and memory, the memory storing a camera control program and a network interface program for transferring camera control commands and image data between the capture station and a remote workstation such that the capture station operates under the control of the remote workstation to capture data for incorporation into an identification document.

2. The station of claim 1 including a lighting device that operates under control of the camera control program in the memory of the computer.

3. The station of claim 1 including a signature capture interface device and signature capture control program in the memory for controlling a signature capture device that captures handwritten signatures.

4. The station of claim 1 including a fingerprint capture interface device and signature capture control program in the memory for controlling a signature capture device that captures handwritten signatures.

5. The station of claim 1 wherein the computer operates in standby mode such that the computer is controllable from the remote workstation without requiring an operator to log on to the computer in the station.

6. The station of claim 1 wherein the camera control program is implemented as a web server and is controllable via a web page executing on a remote, client workstation.

7. The station of claim 1 wherein the computer and camera in the station are shared by two or more workstations that control the station remotely through a network connection established with the network interface program.

8. The station of claim 1 wherein the station includes a video device interface for a video display and an input device interface for enabling an operator to enter alphanumeric input, and the station has at least two modes of operation: a remote control mode in which data capture for identification document creation is controlled from the remote workstation, and stand alone mode control mode in which data capture for identification document creation is controlled from the remote workstation.

9. A method for creating an identification document comprising:
in a first computer workstation, presenting a user interface that enables an operator to enter applicant data and control capture of image information for incorporation into an identification document;
in an all in one capture station having a camera stand, a camera mounted within the camera stand, and a computer integrated into the camera stand; the computer including a processor, network interface device, and memory, executing a camera control program that controls the camera and a network interface program for receiving camera commands through the network interface device;
setting up a network connection between the first computer workstation and the computer in the all in one capture station;
in response to an operator command to capture an applicant portrait entered in the user interface, sending a camera control command to the camera control program in the all in one capture station through the network connection;
receiving a captured image in the first computer workstation in response to the camera control command; and
using the captured image along with other information obtained at the first computer workstation to create an electronic image for printing on an identification document.

10. The method of claim 9 wherein the all in one capture station controls one or more additional biometric capture devices that are controllable via network connections from one or more other computer workstations to capture biometric information used in an identification document enrollment process.

11. The method of claim 10 wherein the one or more additional biometric capture devices include a signature capture device.

12. The method of claim 10 wherein the one or more additional biometric capture devices include a fingerprint capture device.

13. An all in one capture station for creating identification documents comprising:
a camera stand, the camera stand having a base and a slidably attached tower;
a camera mounted within the tower;
a computer integrated into the base of the camera stand; the computer including a processor, network interface device, and memory, the memory storing a camera control program and a network interface program for transferring camera control commands and image data between the capture station and a remote workstation such that the capture station operates under the control of the remote workstation to capture data for incorporation into an identification document.
